(19) United States
(12) Patent Application Publication
(10) Pub. No.: US 2013/0033658 A1
(43) Pub. Date: Feb. 7, 2013

(54) LIQUID CRYSTAL DISPLAY DEVICE

(71) Applicants: Takashi KATO, Chiba (JP); Yukihide ODE, Chiba (JP); Shunichi MATSUMOTO, Chiba (JP); Masato YANAI, Chiba (JP); Shimon ITAKURA, Chiba (JP); Tomohiro MAEYAMA, Kanagawa (JP)

(72) Inventors: Takashi KATO, Chiba (JP); Yukihide ODE, Chiba (JP); Shunichi MATSUMOTO, Chiba (JP); Masato YANAI, Chiba (JP); Shimon ITAKURA, Chiba (JP); Tomohiro MAEYAMA, Kanagawa (JP)

(73) Assignee: PANASONIC LIQUID CRYSTAL DISPLAY CO., LTD., Himeji-shi (JP)

(21) Appl. No.: 13/565,233

(22) Filed: Aug. 2, 2012

(30) Foreign Application Priority Data
Aug. 4, 2011 (JP) 2011-170891
Aug. 4, 2011 (JP) 2011-170892

(51) Int. Cl. G02F 1/1333

(52) U.S. Cl. 349/60

(57) ABSTRACT

In a liquid crystal display device in which a source board (56) connected to a liquid crystal panel by a flex circuit is mounted onto a rear surface of a lower metal frame (54), disconnection in the flex circuit or at a connection portion thereof is avoided. The source board (56) includes a conductor pattern (110) serving as a ground electrode held in contact with the rear surface of the frame (54). A support member (60) for supporting the circuit board (56) is fixed to the frame (54) and includes a cantilever (62) which extends above the source board (56), for pressing the source board (56) against the frame (54). The cantilever (62) enables displacement of the source board (56) along the rear surface of the frame (54) while maintaining a state in which the conductor pattern (110) is held in contact with the frame (54).

### CROSS-REFERENCE TO RELATED APPLICATION

The present application claims priority from Japanese applications JP 2011-170891 and JP 2011-170892 filed on Aug. 4, 2011, the content of which is hereby incorporated by reference into this application.

### BACKGROUND OF THE INVENTION

1. Field of the Invention

The present invention relates to a liquid crystal display device, and more particularly, to a support structure for a circuit board to be connected to a liquid crystal panel via a flexible circuit (flex circuit).

2. Description of the Related Art

A liquid crystal display device includes a liquid crystal module having a liquid crystal panel and a backlight unit. FIG. 10 is a schematic vertical sectional view of a lower part of a conventional liquid crystal module 2. The left side of FIG. 10 corresponds to a front surface side of the liquid crystal display device, that is, a display surface side, and the right side thereof corresponds to a rear surface side of the liquid crystal display device. On the front surface side of the liquid crystal module 2, a liquid crystal panel 4 serving as a display panel is arranged, and a backlight unit 6 is arranged behind the liquid crystal panel 4. Onto the backlight unit 6, a lower metal frame 8 for covering a rear surface of the backlight unit 6 is fitted. An outer periphery of the liquid crystal module 2 is surrounded by a mold frame 10 formed by plastic injection molding. A main part of the liquid crystal module 2 obtained by assembling the liquid crystal panel 4, the backlight unit 6, the mold frame 10, and the like is fitted into an upper metal frame 12 having a frame shape. An outer peripheral lateral surface of the liquid crystal module 2 is covered with the upper metal frame 12.

The liquid crystal panel 4 includes a plurality of pixels arranged in matrix. In accordance with the arrangement of the pixels, on the liquid crystal panel 4, an electronic circuit including a thin film transistor (TFT), a source signal line, and a gate signal line is formed. The liquid crystal module 2 includes a source driver circuit and a gate driver circuit for driving a plurality of source signal lines and a plurality of gate signal lines, respectively, which are arranged on the liquid crystal panel 4. Operations of the respective driver circuits are controlled by a signal processing circuit. Between the circuit of the liquid crystal panel 4 and a signal processing circuit board, for example, a source board 14 is connected. The plurality of source signal lines are horizontally arranged on the liquid crystal panel 4, and hence the source driver circuit for driving the source signal lines is arranged along a horizontal direction of the liquid crystal module. Therefore, the circuit for driving the source signal lines is formed in, for example, a region along a lower edge of the liquid crystal panel 4, and the source board 14 is formed into a shape that is elongated in the horizontal direction along the lower edge as well. The source board 14 and the circuit formed on the lower edge of the liquid crystal panel 4 are connected to each other by a flex circuit 16 on which a plurality of signal lines are arranged. In a case where the number of pixels is large, a plurality of flex circuits 16 are arranged in the horizontal direction.

Conventionally, the source board 14 has been mounted onto the mold frame 10. For example, in the structure illustrated in FIG. 10, the source board 14 is mounted onto a lower surface of the mold frame 10. The grounds of the circuit of the source board 14 and of the circuit of the liquid crystal panel 4 connected to the circuit of the source board 14 are connected via the signal processing circuit board and a power supply board to an AC power source. In this case, when the impedance to the ground is lowered, adverse effects such as spurious emission or electromagnetic interference (EMI) and discharge can be reduced. Therefore, for example, grounding hardware 18 is provided to the source board 14, and the grounding hardware 18 is brought into surface contact with the upper metal frame 12, to thereby lower the impedance to the grounds of the circuits of the source board 14 and the liquid crystal panel 4.

However, recently, in order to thin the bezel and reduce the material cost, in some cases, the upper metal frame 12 has been omitted or the mold frame 10 has been thinned. In this structure, the source board cannot be arranged at the above-mentioned conventional position or cannot be grounded to the upper metal frame 12. Therefore, in this case, there is employed a structure in which the source board is fixed to a rear surface of the lower metal frame 8 with a screw or the like, so as to be grounded to the lower metal frame 8.

### SUMMARY OF THE INVENTION

In the liquid crystal module, the liquid crystal panel is, for example, supported by another member through intermediation of a buffer member, but generally, the liquid crystal panel is not completely fixed. In particular, some looseness may be present in a direction parallel to the display surface. Therefore, for example, when the liquid crystal panel is shifted with respect to the lower metal frame in the horizontal direction along the display surface, because the source board is fixed to the lower metal frame with a screw or the like, there acts a force which tries to bend the flex circuit, which connects together the horizontal edge of the liquid crystal panel and the source board parallel thereto, in a width direction (horizontal direction), which is a direction in which the flex circuit has low flexibility. A stress generated by the force may cause disconnection in the flex circuit or at a connection part between the flex circuit and the liquid crystal panel and the source board, which has been a problem.

Further, in an in-plane switching (IPS) system liquid crystal panel, unlike a vertical alignment (VA) system liquid crystal panel, transmission of light is controlled by rotating liquid crystal molecules in a plane parallel to a glass substrate with use of an electric field component parallel to the glass substrate surface. In this IPS liquid crystal panel, when a stress is applied to a part of the glass substrate, the direction of the liquid crystal molecules at the part is shifted from the direction parallel to the glass substrate surface, which causes color deviation in a display screen. Therefore, there has been a problem that the color deviation occurs due to the above-mentioned stress on the flex circuit.

The present invention has been made to solve the above-mentioned problems, and has an object to provide a structure capable of preventing the above-mentioned disconnection and color deviation in a liquid crystal display device in which a circuit board connected to a liquid crystal panel by a flex circuit is mounted onto a rear surface of a frame.

According to an exemplary embodiment of the present invention, there is provided a liquid crystal display device, including: a panel-like structure including a liquid crystal panel; a frame made of a metal, for covering a rear surface of the panel-like structure; a circuit board placed on a rear surface of the frame and connected to the liquid crystal panel by a flex circuit; and a support member for supporting the circuit board to allow the circuit board to fluctuate along the rear surface of the frame. The circuit board includes a ground electrode held in contact with the rear surface of the frame, and the support member includes: a base portion fixed to the frame; and a cantilever spring which extends above the circuit board from a fixed end provided to the base portion at a position adjacent to the circuit board, for pressing the circuit board against the frame.

According to another exemplary embodiment of the present invention, in the liquid crystal display device, the cantilever spring includes a pressing portion which is pressed against the circuit board at a position on a rear side of the ground electrode. According to a preferred embodiment of the present invention, in the liquid crystal display device, the frame includes, on the rear surface thereof, a convex portion at a position opposed to the ground electrode.

According to another exemplary embodiment of the present invention, in the liquid crystal display device, the base portion of the support member includes a spacer portion, which is positioned between the frame and the circuit board and provided with a protruded portion projecting toward the circuit board, and the circuit board has a positioning hole at a position opposed to the protruded portion, the positioning hole being an opening portion through which the protruded portion is inserted and having a looseness corresponding to a width of fluctuation of the circuit board with respect to a diameter of the protruded portion. According to a preferred embodiment of the present invention, in the liquid crystal display device, the frame has, on the rear surface thereof, a convex portion at a position opposed to the ground electrode, the convex portion projecting out from a surface of the spacer portion provided with the protruded portion.

According to another exemplary embodiment of the present invention, in the liquid crystal display device, the base portion of the support member has an insertion groove into which an edge portion of the circuit board is inserted, and the insertion groove restricts a movement of the edge portion in a normal direction of the circuit board.

According to the exemplary embodiment of the present invention, in the liquid crystal display device, the base portion may have, among steps of the base portion provided to a surface against which the circuit board is pressed, a step that rises when viewed from the circuit board to be inserted from a movable end toward the fixed end of the cantilever spring and is chamfered.

The liquid crystal display device according to the exemplary embodiment of the present invention can be suitably applied to a liquid crystal display device in which the liquid crystal panel employs an in-plane switching display system.

According to an exemplary embodiment of the present invention, there is provided a liquid crystal display device, including: a panel-like structure including a liquid crystal panel; a frame made of a metal, for covering a rear surface of the panel-like structure; a circuit board arranged on a rear surface of the frame and connected to the liquid crystal panel by a flex circuit; and a support member for supporting the circuit board on the rear surface of the frame. The support member includes: a pin-like member, which is made of a metal and has a shaft which passes through an opening portion provided in the circuit board and is fixed at its leading end portion to the rear surface of the frame; and a coil spring formed of a metal wire arranged in a spiral manner around the shaft, one end portion of the coil spring being fixed to the pin-like member and the other end portion being pressed against a front surface of the circuit board by an elastic force. The circuit board has a conductor pattern in a part of the front surface, with which the other end portion of the coil spring is brought into contact, and is grounded to the frame via the support member. The opening portion is formed into a size having a margin with respect to a diameter of the shaft so that the circuit board is movable along the rear surface of the frame.

According to the exemplary embodiment of the present invention, the coil spring may be placed on an opposite side of the circuit board from the frame so as to press the circuit board against the frame.

According to another exemplary embodiment of the present invention, in the liquid crystal display device, the shaft of the pin-like member includes a male screw to be fastened to a threaded hole formed in the frame, the male screw being selectively formed in the leading end portion, and the shaft includes a non-leading end portion in which the male screw is not formed, the non-leading end portion being formed larger in diameter than the leading end portion.

According to another exemplary embodiment of the present invention, in the liquid crystal display device, the margin of the opening portion of the circuit board in a width direction of the flex circuit has a size corresponding to a looseness amount of the liquid crystal panel with respect to the frame in the width direction.

The liquid crystal display device according to the exemplary embodiment of the present invention can be suitably applied to a liquid crystal display device in which the liquid crystal panel employs an in-plane switching display system.

### BRIEF DESCRIPTION OF THE DRAWINGS

In the accompanying drawings:

FIG. 1 is a schematic rear view of a liquid crystal display device according to a first embodiment of the present invention;

FIG. 2 is a schematic vertical sectional view of a liquid crystal module taken along the line II-II of FIG. 1;

FIG. 3 is a schematic partial vertical sectional view of a support part for a source board in the liquid crystal module of the first embodiment;

FIG. 4 is a schematic partial plan view of the source board mounted onto a support member;

FIG. 5 is a schematic rear view of a liquid crystal display device according to a second embodiment of the present invention;

FIG. 6 is a schematic vertical sectional view of a liquid crystal module taken along the line VI-VI of FIG. 5;

FIG. 7 is a schematic partial vertical sectional view of a support part for a source board in the liquid crystal module of the second embodiment;

FIG. 8 is a schematic sectional view of mounting hardware taken along a center of a shaft of the mounting hardware;

FIG. 9 is a schematic plan view of an opening portion of the source board; and

FIG. 10 is a schematic vertical sectional view of a lower part of a conventional liquid crystal module.

### DETAILED DESCRIPTION OF THE INVENTION

Hereinafter, a liquid crystal display device, which is a mode for carrying out the present invention (hereinafter, referred to as embodiment) is described with reference to the drawings.

### First Embodiment

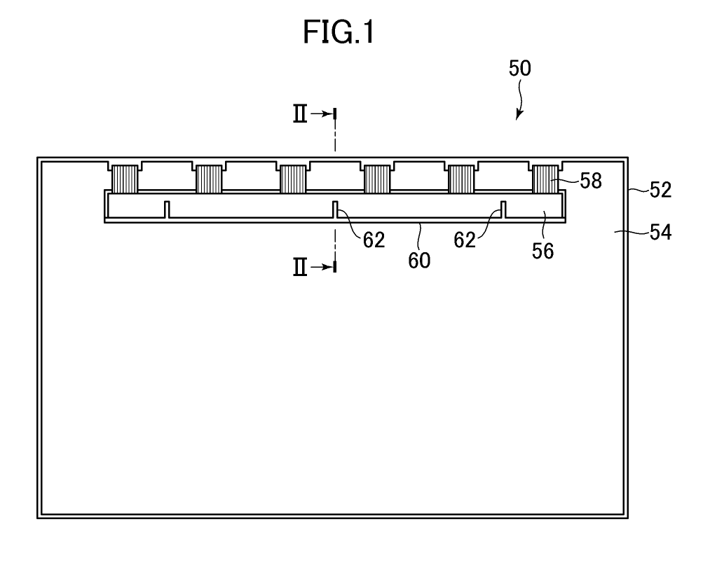

A liquid crystal display device 50 according to a first embodiment of the present invention includes a liquid crystal module, an exterior covering and a stand. FIG. 1 is a schematic rear view of the liquid crystal display device 50, and specifically, illustrates a state in which a liquid crystal module 52 of the liquid crystal display device 50 is viewed from a rear side. The liquid crystal module 52 has a substantially rectangular planar shape so as to correspond to the liquid crystal panel. The liquid crystal module 52 has a structure in which a panel-like structure obtained by assembling components such as a liquid crystal panel and a backlight unit is supported by frame members. In this embodiment, a rear surface of the liquid crystal module 52 is basically covered with a lower metal frame 54 which is one of the frame members, and a mold frame for supporting an edge of the liquid crystal module 52 is provided on an outer periphery of the liquid crystal module 52. The liquid crystal module 52 includes a source board 56 and a signal processing circuit board (not shown) which are mounted on a rear surface of the lower metal frame 54. Those boards are made of a hard material, and for example, a glass epoxy board may be used.

The liquid crystal panel includes a plurality of pixels arranged in matrix. In accordance with the arrangement of the pixels, on the liquid crystal panel, a plurality of source signal lines (data signal lines) and a plurality of gate signal lines (scanning signal lines) are arranged. The liquid crystal module 52 includes a source driver circuit for driving the respective source signal lines, and a gate driver circuit for driving the respective gate signal lines. Operations of the respective driver circuits are controlled by a control signal generated by the signal processing circuit board based on a video signal.

The source board 56 is present on the rear surface of the lower metal frame 54 on the upper side thereof, and extends in a horizontal direction. The source board 56 is connected to an upper edge portion of the liquid crystal panel by a flat cable 58 passing through an upper side of the lower metal frame 54. The flat cable 58 is a flat flexible cable or a flexible printed circuit. Further, the source board 56 is connected to the signal processing circuit board by, for example, a flat cable (not shown). In this embodiment, the number of pixels in the liquid crystal panel is large, and hence six flat cables 58 are arranged in the horizontal direction. The source board 56 is mounted onto the lower metal frame 54 by a support member 60. The support member 60 has a length corresponding to that of the source board 56, and extends in the horizontal direction.

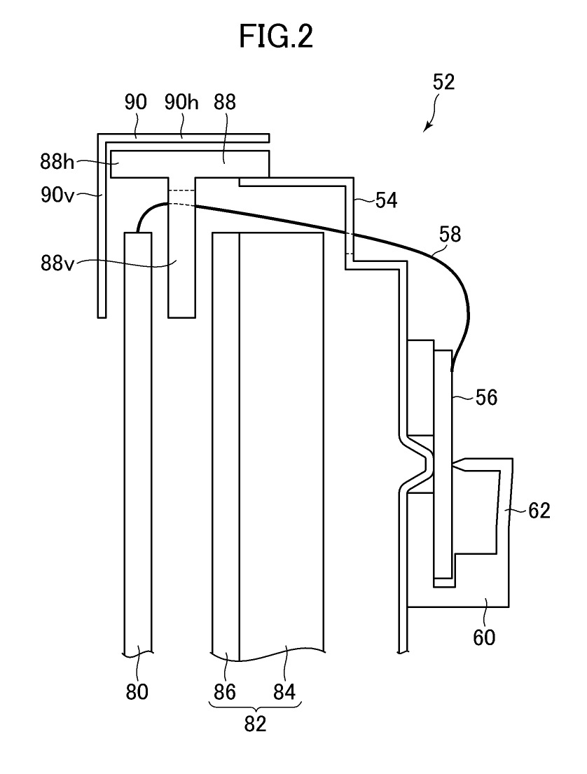

FIG. 2 is a schematic vertical sectional view of the liquid crystal module 52, and is a sectional view taken along the line II-II of FIG. 1. The left side of FIG. 2 corresponds to a front surface side of the liquid crystal display device 50, that is, a display surface side, and the right side thereof corresponds to a rear surface side of the liquid crystal display device 50. On the front surface side of the liquid crystal module 52, a liquid crystal panel 80 serving as a display panel is arranged. The liquid crystal panel 80 includes, although not shown in FIG. 2, a TFT substrate which is a glass substrate on the rear surface side thereof, a counter substrate which is a glass substrate on the front surface side thereof, and a liquid crystal layer sandwiched between those substrates. The liquid crystal panel 80 is a transmissive liquid crystal panel. A lower polarizing plate is arranged on the rear surface of the TFT substrate, and an upper polarizing plate is arranged on the front surface of the counter substrate. A backlight unit 82 is arranged so as to be opposed to the rear surface of the liquid crystal panel 80.

On a surface of the TFT substrate on the liquid crystal side, TFTs are arranged in matrix in accordance with the pixel arrangement. Further, the source signal line is provided on the TFT substrate for each vertical column of the TFTs, and is connected in common to sources of a plurality of TFTs in the vertical column. Further, the gate signal line is provided for each horizontal row of the TFTs, and is connected in common to gates of a plurality of TFTs in the horizontal row. Further, a pixel electrode is connected to a drain of each of the TFTs, which is arranged in a pixel region corresponding to the TFT.

Further, the TFT substrate includes, on the periphery of an effective display region in which the pixels are arranged, drive circuits for supplying signals to the source signal lines and the gate signal lines. A circuit for driving the gate signal lines outputs gate signals to the respective gate signal lines in order, to thereby enable data writing of pixel circuits connected to the gate signal lines. Further, a circuit for driving the source signal lines outputs signals corresponding to the respective plurality of pixels forming one scanning line to the plurality of source signal lines. Pixel signals output to the respective source signal lines are written into pixel circuits which have been enabled to be written by a gate signal, and thus an amount of light to be output from the pixel is controlled based on the pixel signal written to each of the pixel circuits.

The counter substrate includes a color filter, which enables color display of an image. The liquid crystal panel 80 of this embodiment is an IPS liquid crystal panel, and no electrodes are basically formed on the counter substrate.

The drive circuit on the TFT substrate corresponding to the source signal lines is, for example, arranged along an upper edge portion of the TFT substrate, and as described above, a circuit formed on the upper edge portion is connected to the source board 56 by the flat cable 58. In the flat cable 58, a plurality of signal lines are arranged in a width direction of the flat cable 58 so as to correspond to the source signal lines. Further, onto the flat cable 58, an element such as an integrated circuit (IC) may be mounted by a chip on film (COF) technology.

The backlight unit 82 includes a light emitting portion 84 for generating planar light directed toward the liquid crystal panel 80, and an optical sheet group 86 including optical sheets such as a diffusion sheet, which are stacked on a front surface of the light emitting portion 84. Note that, the light emitting portion 84 includes, for example, when employing an edge light system, a light guide plate and a light source for causing light to enter from a lateral surface of the light guide plate, and further, when employing a direct type, a plurality of light sources arranged along an emission surface. As a light source, for example, a light emitting diode (LED) may be used.

The lower metal frame 54 is arranged on a rear surface of the backlight unit 82. The support member 60 is mounted onto the lower metal frame 54, and the source board 56 is mounted onto the support member 60. The support member 60 includes a cantilever 62 that is elongated in a vertical direction. Note that, onto the lower metal frame 54, in addition to the source board 56, for example, the signal processing circuit board and a circuit board such as a receiving circuit, which is used in a case where the liquid crystal display device 50 is a television set, are mounted. The lower metal frame 54 has a box shape in which a peripheral edge portion thereof is bent toward the front surface side, and the backlight unit 82 is housed inside the lower metal frame 54.

A mold frame 88 and an upper metal frame 90 are each formed into an integrated frame along an outer periphery of the liquid crystal module 52. Parts of the mold frame 88 and the upper metal frame 90 illustrated in FIG. 2 are upper-side parts thereof. The mold frame 88 is formed by plastic injection molding, and includes a part 88h horizontal in a front-rear direction of the liquid crystal module 52, and a part 88v vertical to the horizontal part 88h.

The upper metal frame 90 has a cross-section of an L-shape at each side of the frame, and includes a horizontal part 90h arranged on the outer side of the horizontal part 88h of the mold frame 88, and a front surface part 90v extending toward the inner side of the frame from a front end of the horizontal part 90h. Into the frame of the upper metal frame 90, the above-mentioned main part of the liquid crystal module 52 obtained by assembling the liquid crystal panel 80, the backlight unit 82, the lower metal frame 54, the mold frame 88, and the like is fitted. An outer peripheral lateral surface of the liquid crystal module 52 is covered with the horizontal part 90h of the upper metal frame 90, and a front surface outer edge portion thereof is covered with the front surface part 90v.

The vertical part 88v of the mold frame 88 is inserted into a gap provided between the liquid crystal panel 80 and the backlight unit 82, and the liquid crystal panel 80 is held between the vertical part 88v of the mold frame 88 and the front surface part 90v of the upper metal frame 90. A looseness (clearance) is provided between the liquid crystal panel 80 and the horizontal part 88h of the mold frame 88 surrounding the outer periphery of the liquid crystal panel 80. The liquid crystal panel 80 is displaced within the range of the looseness in accordance with the force acting in a direction along the surface thereof, thereby relaxing the stress.

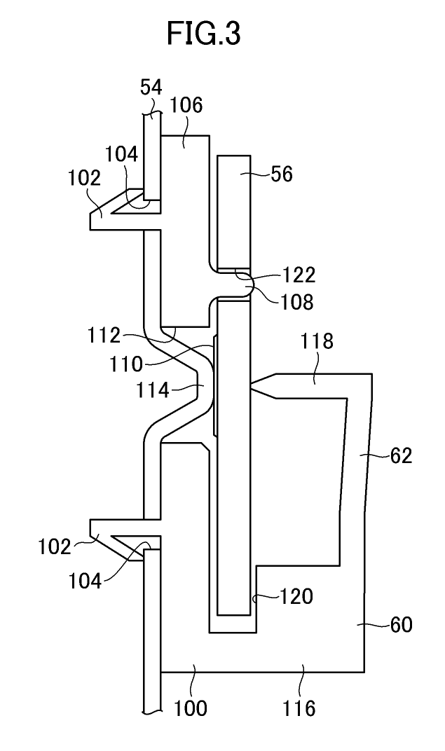

Next, description is made of a support for the source board 56 on the rear surface of the lower metal frame 54. FIG. 3 is a schematic partial vertical sectional view of a support part for the source board 56. The support member 60 includes a base portion 100 and the cantilever 62. For example, the support member 60 can be integrally formed by plastic injection molding. As described later, the cantilever 62 forms a cantilever spring, and hence in the case of integral molding, the support member 60 is made of a material capable of obtaining an elastic force of the cantilever spring. For example, polystyrene and polypropylene may be used as the material.

The base portion 100 extends horizontally and has a length corresponding to that of the source board 56, and is fixed to the lower metal frame 54. For example, protruded portions 102 each having a latch shape are provided to a surface of the base portion 100 to be brought into contact with the lower metal frame 54, and the protruded portion 102 is inserted through a through hole 104 provided in the lower metal frame 54. The latch shape of the protruded portion 102 is formed at a part to be projected from the rear surface of the lower metal frame 54. The latch shape is compressed when passing through the through hole 104, and after the passage, the latch shape is expanded to be larger than the diameter of the through hole 104, thereby fixing the base portion 100 to the lower metal frame 54. Alternatively, the base portion 100 may be fixed to the lower metal frame 54 by other methods such as screwing.

The base portion 100 includes a spacer portion 106 arranged on a part of the lower metal frame 54 facing the source board 56. The spacer portion 106 is positioned between the lower metal frame 54 and the source board 56, and for example, functions as an insulating member, a member for reducing capacitive coupling, and further as a buffer member between the source board 56 and the lower metal frame 54. In addition, the spacer portion 106 of this embodiment includes a protruded portion 108 projected on the source board 56 side. As described later, the protruded portion 108 has a function of positioning the source board 56 and preventing dropping out of the source board 56.

On the source board 56, there is formed a conductor pattern 110 having, for example, an island shape, which is brought into contact with the rear surface of the lower metal frame 54. In a region of the spacer portion 106 facing the conductor pattern 110, an opening portion (spacer opening portion 112) is formed. Further, the lower metal frame 54 has a convex portion 114 formed so as to project toward the source board 56 in the above-mentioned region. The convex portion 114 is projected out from the surface of the spacer portion 106 opposed to the source board 56 (surface provided with the protruded portion 108). The projection amount is set so that the lower metal frame 54 is reliably brought into contact with the conductor pattern 110 of the source board 56 mounted onto the support member 60. For example, the convex portion 114 is formed by press working of the lower metal frame 54.

As described above, the source board 56 is connected to the liquid crystal panel 80 via the flat cable 58 on the upper side of the liquid crystal panel 80, and is basically mounted onto the support member 60 by being slid from the upper side in the vertical direction. Consideration is made so that a shape that may hinder the mounting operation of the source board 56 is not provided on the upper side of the spacer portion 106. From this viewpoint, a fixed end of the cantilever 62 is provided on a lower side of the spacer portion 106. Specifically, the base portion 100 on the lower side of the spacer portion 106 is formed thick, and a wall 116 provided upright from the spacer portion 106 is formed. The cantilever 62 extends from the wall 116 upward in the vertical direction.

The wall 116 includes an insertion groove 120 into which a lower edge portion of the source board 56 is to be inserted. The insertion groove 120 restricts the movement of the inserted edge portion in a normal direction of the source board 56 (front-rear direction of the liquid crystal display device 50). Note that, although not shown in FIG. 3, the insertion groove 120 and the wall 116 extend in the horizontal direction.

Further, considering not to hinder the mounting operation of the source board 56, among steps of the base portion 100 provided to a surface against which the source board 56 is pressed, a step that rises when viewed from the source board 56 to be inserted from a movable end toward the fixed end of the cantilever 62 may be chamfered. In this embodiment, FIG. 3 illustrates a structure in which a lower part of an edge of the spacer opening portion 112 is obliquely chamfered. Through the chamfering, a leading end portion of the source board 56 is less liable to be caught by the corner at the time of insertion thereof, and hence the mounting operation is facilitated.

The cantilever 62 extends above the source board 56 from the wall 116 provided at a position adjacent to the source board 56 mounted onto the support member 60. As illustrated in FIG. 1, the cantilever 62 basically has a shape that is thin in the horizontal direction and long in the vertical direction. As illustrated in FIG. 3, the cantilever 62 includes an arm part extending along the surface of the source board 56, and a pressing portion 118 provided at a leading end of the arm part. The pressing portion 118 is projected from the arm part of the cantilever 62 toward the source board 56, so as to be pressed against the source board 56. The cantilever 62 can warp with a part connected to the wall 116 as a fixed end. The cantilever 62 functions as a cantilever spring and presses the source board 56 against the lower metal frame 54. Specifically, in this embodiment, the conductor pattern 110 of the source board 56 is pressed against the convex portion 114 of the lower metal frame 54.

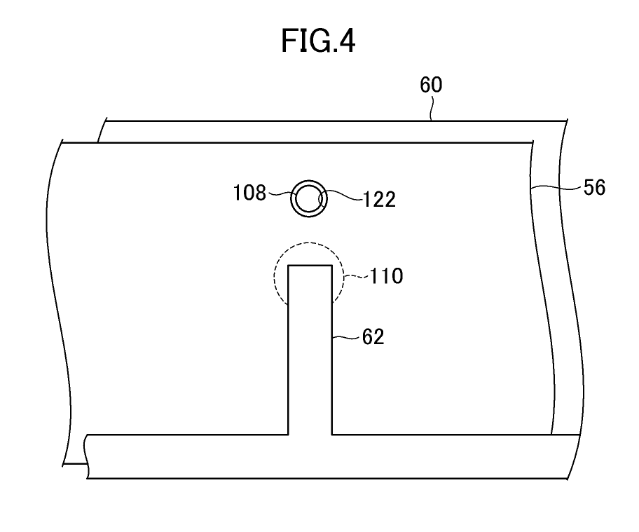

FIG. 4 is a schematic partial plan view of the source board 56 mounted onto the support member 60, and illustrates a surface (referred to as rear surface) of the source board 56 on a side opposite to a surface on which the conductor pattern 110 is formed (referred to as front surface). FIG. 4 illustrates an example of a positional relationship among the conductor pattern 110, the cantilever 62, and the like, and specifically, the pressing portion 118 of the cantilever 62 illustrated in FIG. 3 is pressed against the source board 56 at a position of the source board 56 on the rear side of the conductor pattern 110.

Here, a solder mask is not formed on the conductor pattern 110. The ground of the source board 56 is designed so as to prevent EMI, and the conductor pattern 110 is connected to a pattern of the ground. Through contact of the conductor pattern 110 to the convex portion 114, the ground of the source board 56 is grounded to the lower metal frame 54, to thereby effectively prevent the EMI. Note that, when the copper foil forming the conductor pattern remains exposed to air, the copper foil may be oxidized. As a countermeasure, the conductor pattern 110 is coated with, for example, solder to prevent increase of a contact resistance due to the oxidation. In this manner, a good grounded state is maintained.

The cantilever 62 is used to cause an elastic force to act on the source board 56 mounted onto the support member 60 toward the lower metal frame 54. In this manner, even when the liquid crystal display device 50 shakes due to an external force, a state in which the conductor pattern 110 is held in contact with the convex portion 114 is maintained, and thus a good grounded state is maintained.

In the source board 56, an opening portion (board opening portion 122) is provided at a position opposed to the protruded portion 108 provided to the spacer portion 106. The protruded portion 108 is inserted through the board opening portion 122 so as to provide a positioning function of preventing the source board 56 from being significantly positionally-shifted in the horizontal direction and the vertical direction, and a function of preventing the source board 56 from dropping out from the support member 60. Here, the board opening portion 122 is formed larger than the diameter of the protruded portion 108 so that the source board 56 can swing to some extent in the direction along the surface thereof. The elastic force of the cantilever 62 is adjusted so that the source board 56 can slidably move on the surface of the spacer portion 106.

As described above, the board opening portion 122 is formed larger than the protruded portion 108, and the elastic force of the cantilever 62 is adjusted so that the source board 56 can be easily displaced along the rear surface of the lower metal frame 54. Therefore, when the external force acts on the liquid crystal display device 50 to cause the liquid crystal panel 80 to swing, the source board 56 follows the liquid crystal panel 80 and swings. With this, even when the liquid crystal panel 80 is displaced due to the looseness in the holding structure thereof, stress is prevented from being generated in the flat cable 58 and the liquid crystal panel 80, or the stress is relaxed, and thus disconnection or color deviation can be avoided.

Note that, in order to obtain the above-mentioned effect, it is preferred that the swingable amount of the source board 56 be set so as to correspond to that of the liquid crystal panel 80, and the looseness of the board opening portion 122 with respect to the protruded portion 108 is also set from this viewpoint.

Further, it is preferred that the friction at the contact surface between the pressing portion 118 and the source board 56 be small. For example, the leading end of the pressing portion 118 is formed sharp to reduce the contact area with respect to the source board 56. The insertion groove 120 as well as the cantilever 62 is provided for suppressing displacement in the front-rear direction of the source board 56 in order to secure good grounding of the conductor pattern 110, but the source board 56 is not required to be grasped in the insertion groove 120. The insertion groove 120 is formed to have a groove width which enables insertion of the source board 56 without press-fitting, and is formed so as not to hinder swinging of the source board 56 (in particular, swinging in the horizontal direction).

The conductor pattern 110 and the convex portion 114 have their sizes and shapes set so that the contact state therebetween is maintained even when the source board 56 is swung and displaced.

The conductor pattern 110, the convex portion 114, and the board opening portion 122 may be simply formed into a circle shape. Here, for example, in a case where the liquid crystal display device 50 is a television set, the liquid crystal display device 50 is generally set under a state in which the vertical direction of the liquid crystal panel 80 is vertical. Therefore, the shift of the liquid crystal panel 80 is generally considered to be larger in the horizontal direction than in the vertical direction. Considering this point, it is also preferred to form the conductor pattern 110, the convex portion 114, and the board opening portion 122 into a horizontally long shape.

In the above-mentioned embodiment, the convex portion 114 is projected out from the spacer portion 106, but alternatively, the conductor pattern 110 may be provided with, for example, a solder bump so that the conductor pattern 110 is projected. In this case, the convex portion 114 is not necessarily required to be projected out from the spacer portion 106.

Further, the spacer portion 106 is arranged between the source board 56 and the lower metal frame 54 in consideration of insulation and the like as described above, but when there is no problem in terms of the insulation and the like, it is possible to omit the spacer portion 106.

In the above-mentioned embodiment, the pressing portion 118 of the cantilever 62 is pressed against the source board 56 in a region opposite to the region of the conductor pattern 110 on the rear surface side, but the pressing portion 118 of the cantilever 62 may be pressed in a region other than the above-mentioned region. In addition, a plurality of cantilevers 62 may be provided for one conductor pattern 110.

In the above-mentioned embodiment, the support member 60 is an integrated member that is elongated so as to correspond to the horizontal length of the source board 56, but a plurality of support members 60 each having a length shorter than that of the source board 56 may be arranged in the horizontal direction, and one source board 56 may be supported by the plurality of support members 60.

Further, the protruded portion 108 may be formed into an upwardly-bent L-shape so that the bent leading end portion is caught by the edge of the board opening portion 122, thereby enhancing the function of preventing dropping out of the source board 56.

### Second Embodiment

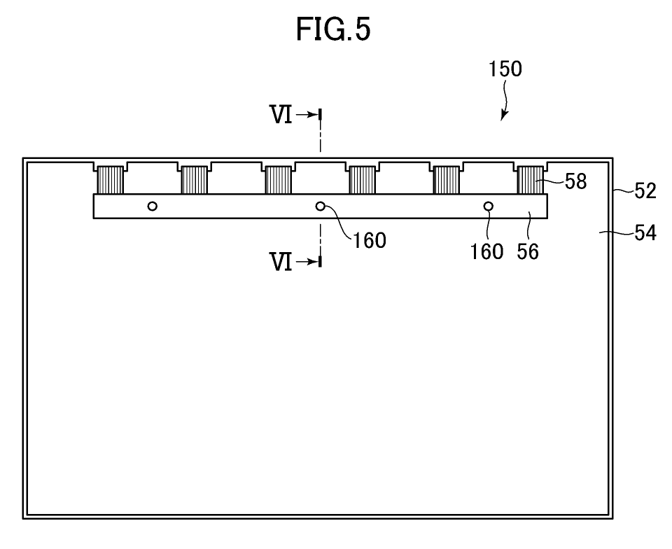

In a liquid crystal display device 150 according to a second embodiment of the present invention, components similar to those of the liquid crystal display device 50 according to the first embodiment are denoted by the same reference symbols, and description thereof is basically omitted. The liquid crystal display device 150 includes a liquid crystal module, an exterior covering and a stand. FIG. 5 is a schematic rear view of the liquid crystal display device 150, and specifically, illustrates a state in which a liquid crystal module 52 of the liquid crystal display device 150 is viewed from a rear side. The liquid crystal display device 150 viewed from the rear surface side illustrated in FIG. 5 and the liquid crystal display device 50 viewed from the rear surface side illustrated in FIG. 1 differ in the structure of mounting the source board 56 onto the lower metal frame 54.

The source board 56 is mounted onto the lower metal frame 54 by mounting hardware 160 (support member). In response to the source board 56 that is elongated in the horizontal direction, the mounting hardware 160 is provided at a plurality of points arrayed in the horizontal direction to support the source board 56.

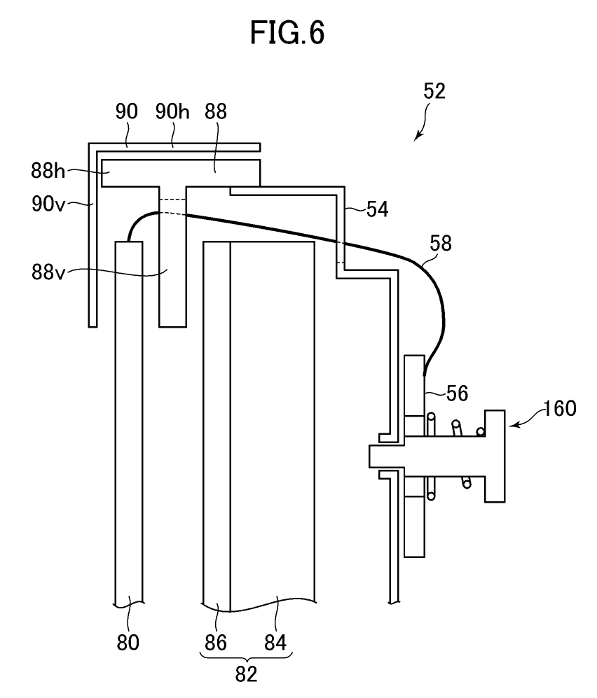

FIG. 6 is a schematic vertical sectional view of the liquid crystal module 52, and is a sectional view taken along the line VI-VI of FIG. 5. FIG. 6 corresponds to FIG. 2 referred to in the first embodiment. The vertical sectional view illustrated in FIG. 6 and the vertical sectional view illustrated in FIG. 2 differ in the structure of mounting the source board 56 onto the lower metal frame 54. In FIG. 6, the source board 56 is mounted onto the lower metal frame 54 by the mounting hardware 160.

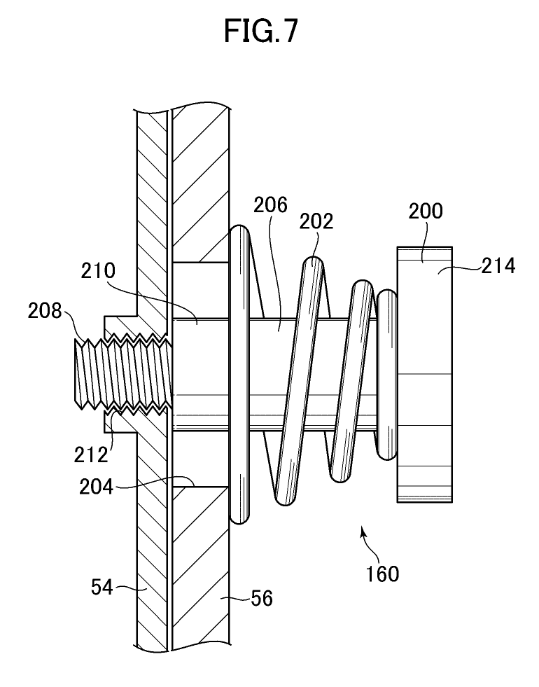

Next, description is made of a support for the source board 56 on the rear surface of the lower metal frame 54. FIG. 7 is a schematic partial vertical sectional view of a support part for the source board 56. The mounting hardware 160 includes a pin-like member 200 and a coil spring 202.

The pin-like member 200 is made of a metal material, and includes a shaft 206 which passes through an opening portion 204 provided in the source board 56 and has a leading end portion fixed to the rear surface of the lower metal frame 54. In this embodiment, a leading end portion 208 of the shaft 206 is subjected to thread cutting to be formed into a male screw. The thread cutting is performed only on the leading end side of the shaft 206. The remaining part of the shaft 206 (non-leading end portion 210) is not subjected to thread cutting, and is formed to be larger in diameter than the leading end portion 208. The length of the non-leading end portion 210 is set so that, in a state (mounting state) in which the mounting hardware 160 is fixed to the lower metal frame 54 to support the source board 56, a predetermined length of the non-leading end portion 210 is projected from the source board 56. The coil spring 202 is arranged at this projected part as described later, and the predetermined length is determined based on the desired height of the coil spring 202 in the mounting state of the mounting hardware 160.

The lower metal frame 54 includes a threaded hole 212 formed in conformity with the male screw of the leading end portion 208. The source board 56 generally has an elongated shape, and in this case, as illustrated in FIG. 5, it is preferred that a plurality of points of the source board 56 in a longitudinal direction thereof are supported by the mounting hardware 160. In response to this, the opening portions 204 are formed at a plurality of points in the source board 56, and a plurality of the threaded holes 212 are formed in the lower metal frame 54 in an arrangement corresponding to those opening portions 204. In this embodiment, the lower metal frame 54 is formed of a relatively thin metal plate. Therefore, in order to obtain a female screw, the threaded hole 212 is formed by burring process.

The male screw of the leading end portion 208 of the shaft 206 is screwed into the threaded hole 212 to be fastened, and thus the pin-like member 200 is fixed to the lower metal frame 54.

The coil spring 202 is formed of a metal wire having elasticity. Further, the metal wire is preferred to be made of a rust-resistant material, for example, stainless steel. The coil spring 202 is arranged in a spiral manner around the shaft 206, and has one end portion (hereinafter referred to as “first end”) fixed to the pin-like member 200 and the other end portion (hereinafter referred to as “second end”) pressed against a front surface of the source board 56 by the elastic force. The coil spring 202 is basically formed separately from the pin-like member 200. The shaft 206 is caused to pass through the inner side of the coil, and thus the coil spring 202 and the pin-like member 200 are assembled to each other to form the mounting hardware 160. For example, the pin-like member 200 is provided with a head portion 214. The head portion 214 is projected from the non-leading end portion 210 in a radial direction of the shaft 206. The head portion 214 is used as the screw head, and also used for fixation of the first end of the coil spring 202. Specifically, the coil diameter at the first end of the coil spring 202 is formed so that the first end can be caught by the head portion 214. With this, in the mounting state of the mounting hardware 160, the first end of the coil spring 202 remains at a boundary between the shaft 206 and the head portion 214.

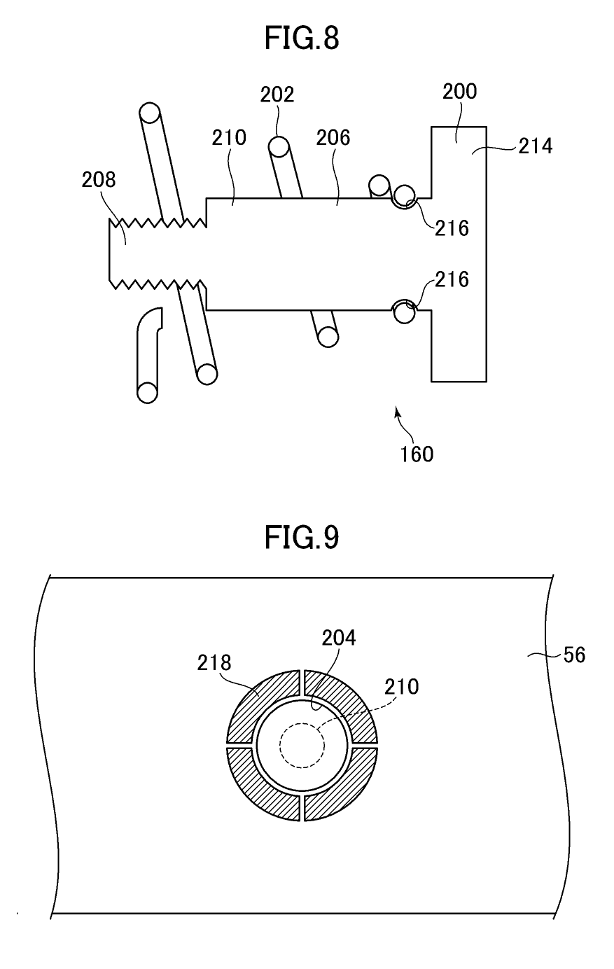

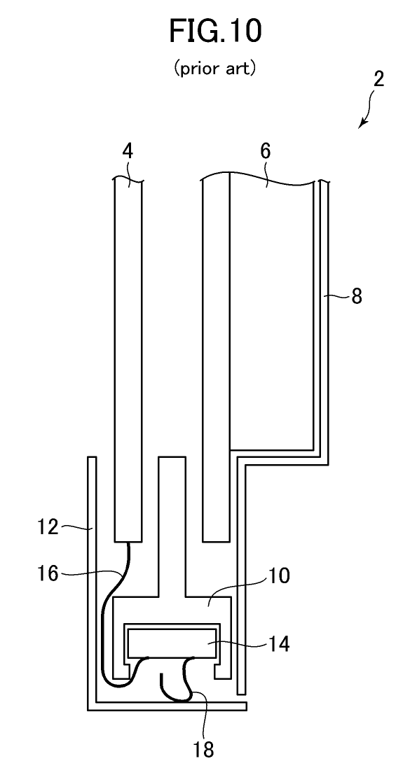

Alternatively, a notch (recess) may be formed along the periphery of the non-leading end portion 210 of the pin-like member 200, and the first end of the coil spring 202 may be stopped so as to engage with the notch (recess). FIG. 8 is a view illustrating the above-mentioned structure, and is a schematic sectional view taken along the center of the shaft 206 of the mounting hardware 160. The non-leading end portion 210 has, for example, a notch 216 formed at a position on the head portion 214 side. Then, the first end portion of the coil spring 202 is formed into a ring having a smaller diameter than that of the non-leading end portion 210, and the ring remains in the notch 216 by the elastic force thereof. In this structure, even in a non-mounting state of the mounting hardware 160, that is, a state in which the second end of the coil spring 202 is not held in touch with the source board 56, the coil spring 202 is fixed to the pin-like member 200. In this structure, during the operation of mounting the source board 56 to the lower metal frame 54 with use of the mounting hardware 160, it is unnecessary to press the coil spring 202 so that the coil spring 202 does not drop out from the pin-like member 200. Thus, the working efficiency is enhanced.

FIG. 9 is a schematic plan view of the opening portion 204 of the source board 56, and illustrates a surface of the source board 56 on a side on which the coil spring 202 is to be placed. At the circumference of the opening portion 204, a conductor pattern 218 is formed. Specifically, the conductor pattern 218 is provided at a part of the front surface of the source board 56, with which the second end of the coil spring 202 is brought into contact. A solder mask is not formed on the conductor pattern 218. The ground of the source board 56 is designed so as to prevent EMI, and the conductor pattern 218 is connected to a pattern of the ground. Through contact of the coil spring 202 to the conductor pattern 218, the ground of the source board 56 is grounded to the lower metal frame 54 via the mounting hardware 160, that is, via the coil spring 202 and the pin-like member 200, to thereby effectively prevent the EMI. Note that, when the copper foil forming the conductor pattern remains exposed to air, the copper foil may be oxidized. As a countermeasure, the conductor pattern 218 is coated with, for example, solder to prevent increase of a contact resistance due to the oxidation. In this manner, a good state of grounding via the mounting hardware 160 is maintained.

The mounting hardware 160 is used to cause an elastic force of the coil spring 202 to act on the source board 56 mounted onto the lower metal frame 54 toward the lower metal frame 54. With this, the source board 56 is basically pressed against the lower metal frame 54, but due to some kind of external force, the source board 56 may be temporarily separated from the lower metal frame 54. However, even when the source board 56 is displaced in the direction of the shaft 206, a state in which the coil spring 202 is held in contact with the conductor pattern 218 is maintained, and thus the grounding of the source board 56 via the mounting hardware 160 is maintained.

The size of the opening portion 204 is designed so as to have a margin with respect to the diameter of the non-leading end portion 210 of the shaft 206, which is caused to pass therethrough. That is, an edge of the opening portion 204 is not held in contact with the non-leading end portion 210, and a clearance is provided between the edge of the opening portion 204 and the non-leading end portion 210. In this manner, the source board 56 can be shifted with respect to the shaft 206.

The coil spring 202, which is formed of a linear metal member having a substantially circular cross section, can easily deform in an axial direction perpendicular to the coil face, and also in a lateral direction along the coil face. That is, unlike a washer and the like, the coil spring 202 is laterally warped with a relatively small force. Further, the elastic force of the coil spring 202 in the axial direction is adjusted so that the second end of the coil spring 202 can slidably move on the front surface of the source board 56. Specifically, the elastic force can be adjusted through adjustment of the material, diameter, cross-sectional shape, and coil turns of the wire member forming the coil spring 202.

As described above, the opening portion 204 is formed larger than the shaft 206, and the elastic force of the coil spring 202 is adjusted so that the source board 56 can be easily displaced along the rear surface of the lower metal frame 54. Therefore, when the external force acts on the liquid crystal display device 150 to cause the liquid crystal panel 80 to stir, the source board 56 follows the liquid crystal panel 80 and slides. With this, even when the liquid crystal panel 80 is displaced due to the looseness in the holding structure thereof, stress is prevented from being generated in the flat cable 58 and the liquid crystal panel 80, or the stress is relaxed, and thus disconnection or color deviation can be avoided.

Note that, the coil spring 202 has a big role of supplying a ground potential through contact to the conductor pattern 218 even when the source board 56 is displaced as described above. In view of this role, the elastic force of the coil spring 202 can be set relatively weak. That is, the coil spring 202 acts as a dumper with respect to the displacement of the source board 56 in the direction of the shaft 206 and has a function of restoring the displacement into a state in which the source board 56 is pressed against the lower metal frame 54. However, the elastic force of the coil spring 202 is not increased for enhancement of this function, and is rather adjusted to be relatively weak so as not to hinder the lateral displacement of the source board 56.

Further, the conductor pattern 218 provided at the circumference of the opening portion 204 of the source board 56 is designed so that, regardless of the displaced position of the source board 56, the contact between the second end of the coil spring 202 and the conductor pattern 218 is maintained.

As described above, the non-leading end portion 210 is larger in diameter than the leading end portion 208, and hence even when the threaded hole 212 is formed so as to pass through the lower metal frame 54, only the leading end portion 208 of the shaft 206 can enter the lower metal frame 54. That is, in a state in which the mounting hardware 160 is screwed to the fullest extent, the height of the coil spring 202 becomes a predetermined value, and a compression amount of the coil spring 202 is set to a constant value. The elastic force at this time is determined based on specifications such as the material of the coil spring 202 as described above.

The second end of the coil spring 202 is brought into contact with the conductor pattern 218, and hence is formed to have a diameter larger than that of the opening portion 204. Further, the size and shape of the second end are set so that, when the source board 56 is laterally displaced, the second end is not caught by the opening portion 204.

It is preferred that the dimension of the opening portion 204 in the horizontal direction be set so as to correspond to a displaceable amount of the liquid crystal panel 80 in the horizontal direction. For example, the opening portion 204 may be formed into a circular shape having a diameter of the dimension set in this way, or may be formed into an elongated shape having the dimension set in this way in a horizontal dimension and a smaller dimension than the dimension in a vertical dimension. Note that, for example, the first end portion of the coil spring 202 can have a diameter set in accordance with that of the non-leading end portion 210. Meanwhile, the second end thereof is brought into contact with the circumference of the opening portion 204, which is larger than the non-leading end portion 210, and hence the coil spring 202 has a shape in which, for example, a wire member is spirally formed along a conical surface.

In the above-mentioned embodiment, the coil spring 202 is placed on an opposite side of the source board 56 from the lower metal frame 54. Alternatively, the coil spring 202 may be placed between the source board 56 and the lower metal frame 54. For example, in such structure, one end portion of the coil spring 202 positioned on the lower metal frame 54 side is stopped so as to engage with a notch (structure corresponding to the notch 216) provided in the non-leading end portion 210, and the other end portion thereof is brought into contact with a conductor pattern (corresponding to the conductor pattern 218) provided on a rear surface of the source board 56. Under this state, the source board 56, which is pressed by the elastic force of the coil spring 202, is stopped so as to engage with the head portion 214. Further, the one end portion may be pressed against the lower metal frame 54. Even with those structures, the source board 56 is grounded to the lower metal frame 54 via the mounting hardware 160 or the coil spring 202. Further, in the structure in which the coil spring 202 is placed between the source board 56 and the lower metal frame 54, the conductor pattern 218 may be provided to the front surface of the source board 56 similarly to the above-mentioned embodiment, and the conductor pattern 218 may be brought into contact with the head portion 214 of the pin-like member 200. Under this state, the source board 56 can be grounded to the lower metal frame 54 via the pin-like member 200.

In the above-mentioned embodiment, in addition to the conductor pattern 218 formed on the front surface of the source board 56, a conductor pattern connected to the ground of the source board 56 can be exposed on the rear surface thereof, and the conductor pattern may be brought into contact with the lower metal frame 54 at the rear surface of the source board 56 which is pressed against the lower metal frame 54 by the elastic force of the coil spring 202. Similarly, even in the structure in which the coil spring 202 is placed between the source board 56 and the lower metal frame 54, the conductor pattern 218 may be provided on the front surface of the source board 56 in addition to the conductor pattern on the rear surface thereof, and the conductor pattern 218 on the front surface may be brought into contact with the head portion 214. In those structures, grounding to the lower metal frame 54 can be performed on both surfaces of the source board 56, and hence a grounding resistance can be further reduced. Note that, for the reasons that have already been described above, each conductor pattern exposed for grounding is subjected to treatment such as solder coating. Further, the conductor pattern to be brought into contact with the lower metal frame 54 and the conductor pattern to be brought into contact with the head portion 214 may be formed into a convex shape by forming a solder bump and the like, so as to obtain reliable contact with the counterpart.

In the above-mentioned embodiment, as means for fixing the pin-like member 200 to the lower metal frame 54, there is used a screw, which can be obtained by easy working and can be easily mounted and removed of the mounting hardware 160. As another fixing means, for example, there may be used a latch structure in which a part of the leading end portion 208 projected with respect to the rear surface of the lower metal frame 54 expands to be larger than the diameter of the threaded hole 212.

In the above-mentioned embodiment, the threaded hole 212 is directly formed in the thin lower metal frame 54, and hence the threaded hole 212 is a through hole. Alternatively, a boss may be provided to the lower metal frame 54, and the pin-like member 200 may be screwed into a female screw formed in the boss. In this case, the threaded hole 212 may be a hole that does not pass through the boss, and in the mounting state of the mounting hardware 160, a predetermined length of the non-leading end portion 210 may be projected from the source board 56 under a state in which the pin-like member 200 is screwed into the threaded hole 212 to the fullest depth. That is, in this case, the screw-in amount of the pin-like member 200 is determined by the depth of the threaded hole 212, and hence the non-leading end portion 210 is not required to be formed larger in diameter than the leading end portion 208. Therefore, the entire shaft 206 may be formed to have a uniform diameter, and the leading end portion 208 thereof may be subjected to thread cutting. In this manner, the manufacturing cost for the pin-like member 200 can be reduced. Further, the non-leading end portion 210 can be formed thin, and accordingly, the area of the opening portion 204, which becomes a dead space when forming a circuit on the source board 56, can be reduced.

According to the present invention described by means of the first and second embodiments, in the liquid crystal display device in which the circuit board connected to the liquid crystal panel by the flex circuit such as flexible printed circuit (FPC) and flat flexible cable (FFC) is mounted onto the rear surface of the frame, it is possible to avoid disconnection in the flex circuit or at a connection portion thereof, or color deviation in the display screen of the liquid crystal panel.

While there have been described what are at present considered to be certain embodiments of the invention, it will be understood that various modifications may be made thereto, and it is intended that the appended claims coverall such modifications as fall within the true spirit and scope of the invention.

What is claimed is:

1. A liquid crystal display device, comprising:
a panel-like structure comprising a liquid crystal panel;
a frame made of a metal, for covering a rear surface of the panel-like structure;
a circuit board placed on a rear surface of the frame and connected to the liquid crystal panel by a flexible circuit; and
a support member for supporting the circuit board to allow the circuit board to fluctuate along the rear surface of the frame, wherein:
the circuit board comprises a ground electrode held in contact with the rear surface of the frame; and
the support member comprises:
a base portion fixed to the frame; and
a cantilever spring which extends above the circuit board from a fixed end provided to the base portion at a position adjacent to the circuit board, for pressing the circuit board against the frame.

2. The liquid crystal display device according to claim 1, wherein the cantilever spring comprises a pressing portion which is pressed against the circuit board at a position on a rear side of the ground electrode.

3. The liquid crystal display device according to claim 1, wherein the frame comprises, on the rear surface thereof, a convex portion at a position opposed to the ground electrode.

4. The liquid crystal display device according to claim 1, wherein
the base portion of the support member comprises a spacer portion, which is positioned between the frame and the circuit board and provided with a protruded portion projecting toward the circuit board; and
the circuit board has a positioning hole at a position opposed to the protruded portion, the positioning hole being an opening portion through which the protruded portion is inserted and having a looseness corresponding to a width of fluctuation of the circuit board with respect to a diameter of the protruded portion.

5. The liquid crystal display device according to claim 4, wherein the frame has, on the rear surface thereof, a convex portion at a position opposed to the ground electrode, the convex portion projecting out from a surface of the spacer portion provided with the protruded portion.

6. The liquid crystal display device according to claim 1, wherein
the base portion of the support member has an insertion groove into which an edge portion of the circuit board is inserted; and
the insertion groove restricts a movement of the edge portion in a normal direction of the circuit board.

7. The liquid crystal display device according to claim 1, wherein the base portion has, among steps of the base portion provided to a surface against which the circuit board is pressed, a step that rises when viewed from the circuit board to be inserted from a movable end toward the fixed end of the cantilever spring and is chamfered.

8. The liquid crystal display device according to claim 1, wherein the liquid crystal panel employs an in-plane switching display system.

9. A liquid crystal display device, comprising:
a panel-like structure comprising a liquid crystal panel;
a frame made of a metal, for covering a rear surface of the panel-like structure;
a circuit board arranged on a rear surface of the frame and connected to the liquid crystal panel by a flexible circuit; and
a support member for supporting the circuit board on the rear surface of the frame, wherein
the support member comprises:
a pin-like member, which is made of a metal and has a shaft which passes through an opening portion provided in the circuit board and is fixed at its leading end portion fixed to the rear surface of the frame; and
a coil spring formed of a metal wire arranged in a spiral manner around the shaft, one end portion of the coil spring being fixed to the pin-like member and the other end portion being pressed against a front surface of the circuit board by an elastic force;
the circuit board comprises a conductor pattern in a part of the front surface, with which the other end portion of the coil spring is brought into contact, and is grounded to the frame via the support member; and
the opening portion is formed into a size having a margin with respect to a diameter of the shaft so that the circuit board is movable along the rear surface of the frame.

10. The liquid crystal display device according to claim 9, wherein the coil spring is placed on an opposite side of the circuit board from the frame so as to press the circuit board against the frame.

11. The liquid crystal display device according to claim 9, wherein
the shaft of the pin-like member comprises a male screw to be fastened to a threaded hole formed in the frame, the male screw being selectively formed in the leading end portion; and
the shaft comprises a non-leading end portion in which the male screw is not formed, the non-leading end portion being formed larger in diameter than the leading end portion.

12. The liquid crystal display device according to claim 9, wherein the margin of the opening portion of the circuit board in a width direction of the flexible circuit has a size corresponding to a looseness amount of the liquid crystal panel with respect to the frame in the width direction.

13. The liquid crystal display device according to claim 9, wherein the liquid crystal panel employs an in-plane switching display system.
